(19) United States
(12) Patent Application Publication
(10) Pub. No.: US 2001/0031223 A1
(43) Pub. Date: Oct. 18, 2001

(54) Laboratory analyzer system and analytical instrument module

(75) Inventors: Karl Lang, Jona (CH); Albert Aichert, Durnten (CH); Craig Gordon, Nanikon (CH)

Correspondence Address: Friedrich Kueffner, 342 Madison Avenue, Suite 1921, New York, NY, 10173, US

(73) Assignee: Mettler-Toledo GmbH

(21) Appl. No.: 09/813,471

(22) Filed: Mar. 21, 2001

(30) Foreign Application Priority Data
Apr. 14, 2000 (DE) 100 18 876.1

(51) Int. Cl. G01N 35/00

(52) U.S. Cl. 422/64; 422/67

(57) ABSTRACT

A laboratory analyzer system has a base housing (1) on which a sample tray (4) with holding accommodations (5) for two or more samples is movably supported. A drive mechanism (2) inside the base housing advances the sample tray in a stepwise motion so that the samples are presented one by one to a tower-like analytical instrument module (16, 16′) that is installed on the base housing. The mounting arrangement for the analytical instrument module on the base housing is non-destructively releasable, with first connector elements (15) arranged at multiple locations on the base housing and second connector elements on the analytical instrument module. The multiple first connector elements offer the possibilities of installing more than one analytical instrument module on the base housing as well as installing a single instrument module at a choice of different locations on the base housing.

### BACKGROUND OF THE INVENTION

The invention relates to a laboratory analyzer system with a base housing containing a drive mechanism for a sample tray. The sample tray has multiple holding accommodations for samples that are in the process of being analyzed. The drive mechanism advances the sample tray in a stepwise motion so that the samples in the holding accommodations are transported along a prescribed track to an analytical instrument module that is attached to the base housing of the analyzer system. The analytical instrument module has a movable instrument holder by which a sensor electrode or other instrument is dipped into the sample that has been moved into position by the drive mechanism. Analyzer systems of this type are generally used to perform titrations. However, the invention has other conceivable applications and is not limited to titrating apparatus alone.

Analyzer systems meeting the foregoing general description are commercially available in a variety of configurations. The analytical instrument module is generally designed in the shape of a tower rising up from the base housing, so that analytical electrodes, tubes or similar devices can be lowered into a sample cup to perform an analysis (or to wash the electrode or other device after the analysis has been completed). The sample tray is generally a disc-shaped and rotatable. The holding accommodations for the cups with the samples to be analyzed are arranged along the perimeter of the tray. However, the invention is not limited to a carousel configuration. It is also conceivable to use a linear-motion arrangement, e.g., with a rectangular sample tray passing along the analytical instrument module in a straight line.

With an analyzer system of this type, the normal operating procedure is to populate a sample tray with cups containing the samples (which may already have been pretreated) and to place the sample tray on the base housing containing the drive mechanism. Next, in a stepwise motion, one sample after another is advanced to the analytical instrument module. An analytical electrode or other device attached to the instrument module is lowered into the cup; one or more measurements are performed; the device is raised from the cup; and then the same operation is repeated with the next cup. It also needs to be taken into account that certain kinds of analyses such as a conductivity determination and a pH-value determination would influence each other and that it would therefore not be sound practice to perform them with one and the same instrument module. In this type of a situation, it has so far been necessary, after one analysis has been completed, to set the sample on another sample tray and to repeat the entire procedure with a different instrument module.

The foregoing description makes it evident, that a large amount of time is required from the start until the last sample of a sample tray has been analyzed. Consequently, to shorten the time for analyzing large numbers of samples, several analyzer systems have to be used simultaneously, which necessitates a larger investment in space and equipment.

### OBJECTIVE AND SUMMARY OF THE INVENTION

It is therefore the objective of the present invention to expand the versatility of an analyzer system of the type described above, in particular to make its operation more efficient.

The invention shows an unexpectedly simple way to accomplish this objective in an analyzer system of the type described above. The analyzer system according to the present invention has a connector arrangement for installing the analytical instrument module on the base housing, consisting of connector elements that can be non-destructively released and reconnected. The arrangement has first connector elements located on the base housing and a second connector element on the analytical instrument module. The first connector elements are arranged at multiple locations on the base housing, so that two or more analytical instrument modules can be installed on one base housing and/or a single instrument module can be installed at a choice of different locations on the base housing.

In a variation of the same inventive concept, the analyzer system has two or more analytical instrument modules installed on the base housing with any suitable kind of connection, not necessarily designed for non-destructive release.

An analyzer system which in accordance with the invention has two or more analytical instrument modules installed on the base housing opens up a number of entirely new modes of application that can be used individually or in combination. For example:

The analyzer system can be equipped with more sensor probes distributed over the two or more analytical instrument modules for the purpose of performing a greater number of measurements simultaneously.

Measurements that influence each other in an undesirable way can be performed by different analytical instrument modules.

One analytical instrument module can perform the function of preparing each sample, e.g., by adding reagents by means of pipettes, while another analytical instrument module can perform the measurement(s), for example a titration.

On analytical instrument module can perform the measurement, while another module performs a subsequent washing/cleaning function.

One analytical instrument module can perform the measurement and/or the washing and cleaning function while another analytical instrument module removes the sample fluid from its container, e.g., by means of a suction device.

The analyzer system can have two analytical instrument modules at diametrically opposite locations of a carousel system performing the same function, so that twice as many samples can be processed in a given amount of time.

The work load can be split between two or more analytical instrument modules, so that measurements are performed simultaneously instead of sequentially, thereby increasing the throughput rate of the analyzer system.

If the spatial orientation of the analyzer system is dictated because its control key panel is a fixed part of the base housing, the analytical instrument module can be installed either to the left or to the right of the keyboard, whichever is most convenient and suitable for the given task (even if there is no second analytical instrument module installed).

Because of the modular design of the analyzer system, it is possible to expand an existing analyzer system (e.g., if there is an increase in the workload) by adding one or more analytical instrument modules and thereby save the cost as well as the space required for a complete additional analyzer system.

If an analyzer system has at least two analytical instrument modules performing different tasks, it is advantageous if at least one pre-programmed analysis method can be run on each analytical instrument module by means of at least one programmer unit, or if at least two preprogrammed analysis methods can be run simultaneously on the analyzer system by means of at least one programmer unit, where the selection of which program to run on each instrument module is made by means of a connectable controller device.

The invention provides that the analytical instrument module as a vertical, tower-like arrangement is separable from the analyzer system and can exist as an independent part. The scope of the invention expressly includes an analytical instrument module equipped with

a) at least one instrument holder by which an analytical sensor probe or other instrument can be lowered and raised to perform measurements on samples that are delivered in cups to the analytical instrument module, and

b) a non-destructively releasable connector arrangement for installing the analytical instrument module on a base housing.

Further details of the invention will be discussed in the context of the following examples of embodiments of the invention which are schematically illustrated in the drawings.

### BRIEF DESCRIPTION OF THE DRAWING

In the attached drawing:

FIG. 1 shows an analyzer system according to the invention in an exploded perspective view;

FIG. 2 represents a cross-section in a plane defined by the axis II-II and the central vertical axis in FIG. 1;

FIG. 3 represents a variation of the inventive analyzer system in a perspective view similar to FIG. 1.

### DESCRIPTION OF PREFERRED EMBODIMENTS

A base housing 1 contains a drive mechanism 2 (indicated in broken lines) that serves to rotate a disc-shaped sample tray 4 about a vertical shaft 3. The sample tray 4 has multiple holding accommodations 5 in the shape of openings for sample cups along a circular perimeter. The sample tray 4 has a handle 6 so that, after the tray has been filled with samples, it can be grasped by the handle 6 and set down on the shaft 3 that protrudes from the housing 1. The end of the shaft 3 can, for example, be engaged in a keyed coupler opening (not shown) underneath the handle 6 so that the tray 4 is constrained to share the rotation of the shaft 3.

The sample tray 4 can have code markings at its underside (which can be encoded magnetically, optically, or by some other method), for example to instruct the analyzer system about the kinds of analyses to be performed on the samples in the holding accommodations 5 and/or the steps to be performed by the drive mechanism. For example, a procedure may require that only the contents of every other sample be analyzed according to a certain program, and that the samples at the intervening positions be analyzed according to a different program (as will be discussed below). At least one stationary pick-up device (7 and/or 7′) installed in the top of the base housing 1 serves to read the markings that are arranged, e.g., at the locations 8 of the sample tray 4. The result of the reading is transmitted to a programmer unit 9 which, in turn, either issues commands to the drive mechanism 2 by way of a connection 10 and/or forwards the data signal through an internal connection 11 and a plug-connected cable 11′ to a controller unit 12, appropriately provided in the form of a computer. The computer 12 can at the same time be used to process the measurement data delivered through cables 13 (shown only in part, i.e., without the sensor probes to which the cables 13 are connected).

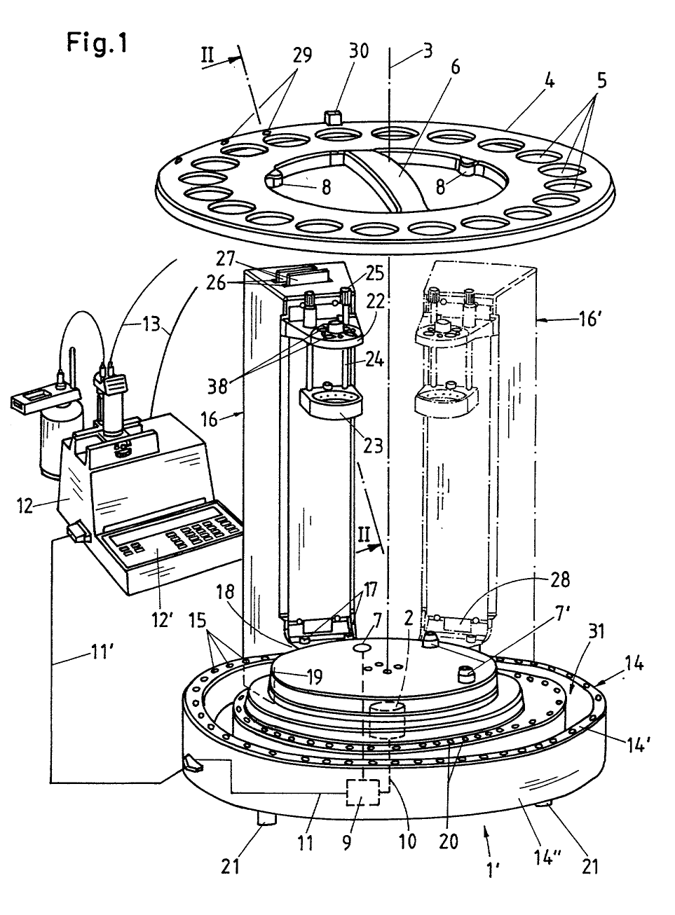

The base housing 1 has a flange 14 substantially in the shape of a ring wall rising vertically around the perimeter of the base housing 1. Mounting holes 15 are distributed along the top surface 14′ of the flange 14. The distances between neighboring mounting holes 15 correspond either exactly to the distance between the holding accommodations 5 of the sample tray 4 or to an equally subdivided part of the distance, e.g., one half (as in the illustrated example of FIG. 1) or one fourth. The outside wall surface 14″ of the flange 14 stands at an angle, typically perpendicular, to the substantially horizontal top surface 14′. When an analytical instrument module configured as a tower 16 is fastened to the mounting holes 15 by means of fastening screws 17, a foot 18 of the tower 16 rests on the top surface 14′, while a vertical surface 19 rests against the wall 14″. This mounting arrangement ensures a stable installation of the tower 16 on the perimeter flange 14 with only two fastening screws 17, with the surface areas 18, 19 of the tower 16 being supported by the-surface areas 14′, 14″ of the perimeter wall 14.

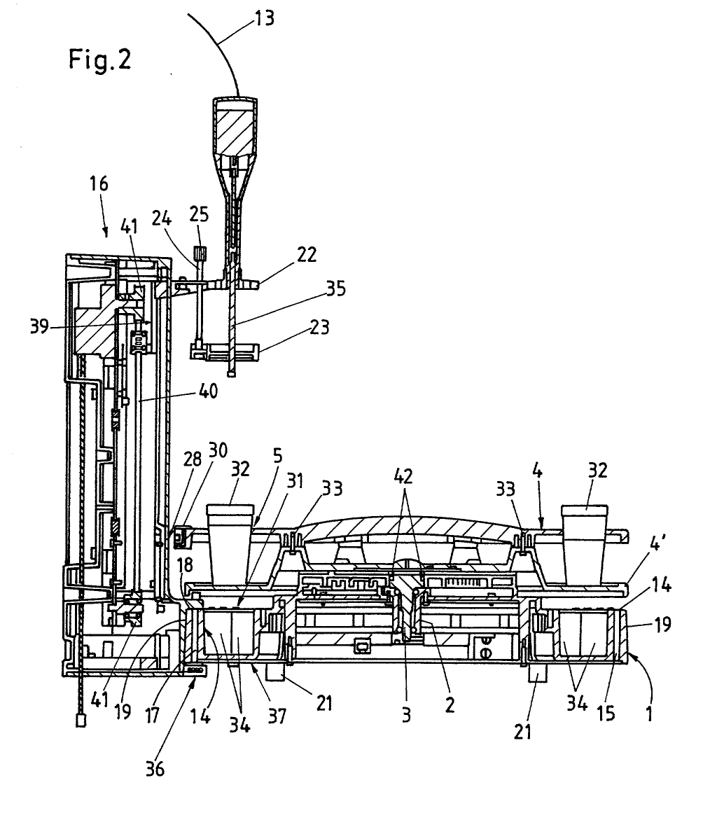

It is self-evident that one could also conceive of arrangements with more than two fastening screws 17. The mounting holes, likewise, could be arranged differently, e.g., as a ring of mounting holes 20. In place of the fastening screws, one could use dowels, pegs, pins, claws, or other suitable fastening means. There could also be more support surfaces in addition to or in place of the surfaces 18, 19. For example, if the tower 16 had a third contact surface opposing the surface 19 and facing the inside of the flange 14, the tower could be seated astride the flange 14. It is also conceivable to provide the tower 16 with an additional horizontal contact surface opposing the foot 18 and facing the underside of the base housing 1. An example of the latter arrangement is illustrated in FIG. 2, where a plate 36 protruding horizontally at the bottom end of the tower forms a U-shaped bracket together with the surfaces 18, 19. The plate 36 lies against the bottom surface 37, and the mounting screws run all the way through the foot 18, the flange 14 and the plate 36. The vertical space for the plate 36 is available because the base housing is elevated from the work surface of a laboratory counter (not shown) by feet 21 which could, e.g., be adjustable for precise leveling of the analyzer system.

The analytical instrument module or, to use a more general term, the tower 16, is advantageously equipped with a ring-shaped washer device 23 arranged below an instrument holder 22 for electrodes, pipettes and other instruments. The term “analytical instrument module” is to be taken in the widest sense, because the module may also be used to perform ancillary functions of the analysis such as washing the instruments or vacuum-aspirating the sample fluid from the cup for disposal. The washer device 23 is suspended from the instrument holder 22 by the rods 24 which are solidly connected to the washer device 23 but can slide up and down in the instrument holder 22, limited by retainer stops 25. In the lowered position of the instrument holder 22, the washer device 24 sits on the rim of the sample cup. When the instrument holder 22 is retracted upward from the sample cup, the washer device 23 is lifted off as soon as the retainer stops 25 are engaged by the instrument holder. This arrangement provides the washer device 23 with a limited range of vertical movement in relation to the instrument holder 22 when the latter is moved up or down within the interval where the washer device 23 is sitting on the rim of the cup and the retainer stops 25 are clear of the instrument holder. The foregoing concept for the washer device 23 is described in the German patent application 10001895.5 which is hereby incorporated by reference in the present description.

Two insertion slots 26 are shown in the top surface of the tower 16, where program cards can be inserted that define the program for the analysis to be performed. A selection between the two programs of the two cards 27 can be made, if necessary, by entering an appropriate command through the keyboard 12′ of the computer 12. However, this represents only one possibility among many. The insertion slots 26 do not necessarily have to be located at the position illustrated, nor is it required to have program cards that are insertable into slots. Rather, the programs (not limited to two) could also reside in hard-wired components inside the base housing 1 or in each of the towers 16, or they could be software programs in the computer 12, where they could be selectively called up by keyboard commands. However, it has proven to be advantageous to incorporate the programs in the respective instrument module or tower 16 that each program is associated with, because such an arrangement makes it easier and more transparent with a plurality of towers to assign different tasks to the individual towers (a second tower 16′ is shown in broken lines).

A further advantage arises from the fact that each tower can be equipped with its own pick-up device 28 to direct the program or the sequence of motions. The pick-up device can, for example, consist of a Hall effect sensor, to sense the presence of magnets 30 that can be plugged into any of the receptacle holes 29 associated with each of the sample-holding cut-outs 5. This arrangement can be used, e.g., in combination with entering a corresponding instruction into the computer 12, to initiate a special program subroutine if a sample is marked by the presence of a plug-in magnet. For example, the special subroutine could be to exempt the marked samples from a pH-test and therefore advance those samples through the pH-testing tower without performing a pH measurement. Thus, if the sample tray 4 is stopped, e.g., to perform an analysis on one sample at the tower 16′, another sample could at the same time be kept waiting at the other tower without lowering the instrument holder of tower 16 because the sample at that location is marked by a plug-in magnet 30. In another case, if samples marked by magnets 30 arrive simultaneously at both of the towers 16 and 16′, an appropriate program-routine could cause the sample tray 4 to be advanced immediately by another step interval. As is self-evident, the pick-up device 28 can work in any number of different ways, e.g., to pick up a line or color mark, or any other mark on the sample tray 4 instead of a plug-in magnet.

It is in no way an absolute requirement to provide on the base housing 1 a flange 14 that delimits a ring channel 31 as it does in the illustrated embodiment of FIG. 1. The purpose of the ring channel 31 will be explained below on the basis of FIG. 2, which also serves to visualize details of the sample tray 4 that are not shown in the coarse schematic representation of FIG. 1.

FIG. 2 shows two sample cups 32 seated in corresponding cut-outs 5 of the sample tray 4. According to FIG. 1, the sample tray is configured simply as a disc, which is in fact a design possibility encompassed by the invention. In contrast, FIG. 2 shows a further developed embodiment consisting of two discs 4 and 4′ attached to each other by screws 33. The lower disc 4′ provides the standing surface for the sample cups 32. Furthermore, the lower disc 4′ has coupling pins 42 designed to engage corresponding holes arranged in the upward-facing end of the shaft 3.

While the lower disc 4′ in the illustrated embodiment is designed to provide an uninterrupted standing surface for the sample cups 32, the invention also encompasses different designs where the lower disc 4′ has openings aligned with the cut-out openings 5 of the upper disc 4 for the purpose of allowing any form of energy to reach the cups 32 from energy sources 34 (in the most general sense of the word) arranged in the ring channel 31. The energy can be, for example, heat from a heater element to warm up the sample in a beaker 32 while it is stopped at the tower 16 (where the pipette or electrode or other instrument 35 seated in the instrument holder 22 could be supplemented, e.g., by a temperature sensor). As another possibility, the energy could be ultrasound from an ultrasonic vibrator. The energy source 34 could also be the energizing unit of a magnetic stirrer to stir the sample in the cup 32. It is also possible within the scope of the invention to have two different energy sources arranged side by side in the ring channel 31, which could be switched on and off selectively by signals from the pick-up devices 7, 7′ (FIG. 1), or 28. If the pick-up device 28 is used for this purpose, the tower 16 will, of course, have to be equipped with appropriate electrical connectors to transmit the signal from the pick-up device 28 to the energy source.

Although covered in the German patent application 10001895.5 cited above as a reference, the following detail features of the tower 16 (or 16′) shall be briefly described in the interest of giving a complete description of the invention. The instrument holder 22, which will normally have several openings 38 to receive electrodes, pipettes, tubes, thermometers and other sensor probes, is connected to a sliding support arrangement 39 which is movable up and down by means of a chain drive with a chain 40 and chain gears 41. The vertical drive arrangement 40, 41 is controlled as described in the aforementioned German patent application, in order to dip a sensor probe or electrode 35 into a sample in a sample cup 32 and to subsequently retract the probe from the sample. The measurement data acquired by the probe 35 are transmitted through one of the aforementioned cables 13 (FIGS. 1 and 2) to the computer 12 for processing.

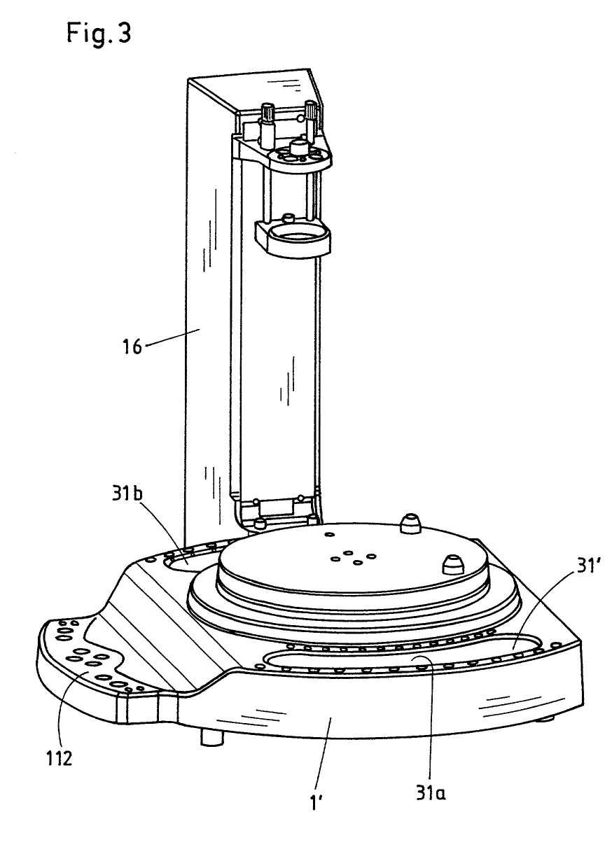

The embodiment of FIG. 13 is distinguished from the embodiment of FIG. 1 in that the key panel 112 for entering data and program commands (corresponding to the key panel 12′ of FIG. 1) is configured as an integral part of the base housing 1′. In an analyzer system with an integral key panel as shown in FIG. 3, there would be no need for a 360° ring channel like the ring channel in the embodiment of FIG. 1. A more practical arrangement to use in combination with the integral key panel consists of sector-shaped channels 31a and 31b to the right and left of the key panel, respectively, because a tower at the front would interfere with the keyboard or at least be inconvenient. As another possible benefit of the arrangement of FIG. 3, if only one tower 16 is used, the user will have a choice of installing the tower 16 either to the right on the sector 31a or to the left on the sector 31b, depending on the nature of the task to be performed, ambient light conditions, or other factors.

What is claimed is:

1. A laboratory analyzer system comprising a base housing, a sample tray movably supported on the base housing, holding accommodations arranged on the sample tray to hold at least two samples subjected to an analysis, a drive mechanism arranged inside the base housing and operable to move the sample tray so that the samples seated in the holding accommodations are advanced in a stepwise motion along a prescribed track, and at least one analytical instrument module installed on the base housing along the prescribed track and operable to analyze the samples as they arrive at the instrument module; wherein the analytical instrument module is installed by means of an at least two-part non-destructively releasable connector arrangement consisting of first connector elements arranged at multiple locations on the base housing and at least one second connector element arranged on the analytical instrument module, thereby providing the options of installing more than one instrument module on the base housing as well as installing a single instrument module at a choice of different locations on the base housing.

2. A laboratory analyzer system comprising a base housing, a sample tray movably supported on the base housing, holding accommodations arranged on the sample tray to hold at least two samples subjected to an analysis, a drive mechanism arranged inside the base housing and operable to move the sample tray so that the samples seated in the holding accommodations are advanced in a stepwise motion along a prescribed track, and at least two analytical instrument modules installed on the base housing along the prescribed track and operable to analyze the samples as they arrive at each analytical instrument module.

3. The laboratory analyzer system according to either claim 1 or claim 2, wherein the sample tray is a rotatable, disc-shaped tray and the drive mechanism is a rotary drive mechanism operable to rotate the sample tray.

4. The laboratory analyzer system according to claim 1, wherein the first connector elements are arranged over at least a segment of an imaginary circle on the base housing.

5. The laboratory analyzer system according to claim 1, wherein the base housing comprises an upright wall-like flange with at least a first support surface and a second support surface for installing the at least one analytical instrument module, said support surfaces enclosing an angle of substantially 90° with each other.

6. The laboratory analyzer system according to claim 5, wherein the base housing has an underside comprising a third support surface oriented substantially parallel to the first support surface, and the at least one analytical instrument module has a mounting portion embracing said first, second and third support surfaces when the instrument module is installed on the base housing.

7. The laboratory analyzer system according to claim 5, further comprising an energy source arranged in a recessed channel delimited by the flange and extending over at least a segment of a circle.

8. The laboratory analyzer system according to either claim 1 or claim 2, further comprising at least one programmer unit adapted to run at least one predetermined analysis program on each analytical instrument module.

9. The laboratory analyzer system according to claim 8, further comprising a connectable controller device, wherein the at least one programmer unit is adapted to run at least two predetermined analysis programs and the controller device is operable to select which of the predetermined analysis programs is to be run on each analytical instrument module.

10. The laboratory analyzer system according to claim 9, wherein the controller device comprises a computer that is operable for the processing of results of the analysis.

11. The laboratory analyzer system according to claim 10, wherein the computer comprises a key panel that is connected to the base housing.

12. The laboratory analyzer system according to either claim 1 or claim 2, comprising at least one motion-controlling arrangement operable to control the movements of at least one of the drive mechanism and the at least one analyzer system.

13. The laboratory analyzer system according to claim 12, wherein the motion-controlling arrangement comprises at least one sample-associated mark on the sample tray and at least one stationary pick-up device operable to read the sample-associated mark, said stationary pick-up device being located on at least one of the base housing and the at least one analytical instrument module.

14. The laboratory analyzer system according to claim 13, wherein the sample-associated mark is attachable to the sample tray by means of a non-destructively releasable attachment element associated with each holding accommodation.

15. The laboratory analyzer system according to claim 8, comprising at least one motion-controlling arrangement operable to control the movements of at least one of the drive mechanism and the at least one analyzer system, wherein at least one of the predetermined analysis program and the motion-controlling arrangement comprises code markings on the sample tray and a stationary pick-up device, and wherein the reading of the code markings is performed as part of an initializing step in which the sample tray is moved by the stationary pick-up device through a full revolution.

16. An analytical instrument module for installation in the laboratory analyzer system according to claim 1, comprising at least one instrument holder that holds at least one instrument and is movable to lower the instrument into a sample and retract the instrument from the sample; and further comprising a mounting portion containing the at least one second connector element, said mounting portion being adapted for engagement with the base housing.

17. The analytical instrument module of claim 16, wherein the at least one second connector element comprises at least two fasteners at a horizontal distance from each other, selected from the group of fasteners consisting of pegs, pins and screws.

18. The analytical instrument module of claim 16, wherein the mounting portion comprises at least two mounting surfaces oriented substantially at a right angle to each other.

19. The analytical instrument module of claim 18, wherein the mounting portion comprises three mounting surfaces in a substantially U-shaped arrangement.
